(19) United States
(12) Patent Application Publication
(10) Pub. No.: US 2016/0269251 A1
(43) Pub. Date: Sep. 15, 2016

(54) Subscription for Communication Attributes

(71) Applicant: Microsoft Technology Licensing, LLC, Redmond, WA (US)

(72) Inventors: Amer Aref Hassan, Kirkland, WA (US); Gunter Leeb, Redmond, WA (US); Pascal Francis Menezes, Bellevue, WA (US)

(21) Appl. No.: 14/657,339

(22) Filed: Mar. 13, 2015

(51) Int. Cl. H04L 12/24; H04L 29/08

(52) U.S. Cl. CPC H04L 41/5054; H04L 67/16

(57) ABSTRACT

Techniques for subscription for communication attributes are described. According to various embodiments, communication attributes include various descriptive information and state information for entities and data flows across a communication system. According to various embodiments, entities involved in a communication system can subscribe to receive various communication attributes including extended attributes not explicitly identified as being available from a particular entity. According to one or more embodiments, various actions can be performed based on communication attributes, such as to optimize communication performance across a communication system.

### BACKGROUND

Modern communication systems have an array of capabilities, including integration of various communication modalities with different services. For example, instant messaging, voice/video communications, data/application sharing, white-boarding, and other forms of communication may be combined with presence and availability information for subscribers. Such systems may provide subscribers with the enhanced capabilities such as providing instructions to callers for various status categories, alternate contacts, calendar information, and comparable features. Furthermore, collaboration systems enabling users to share and collaborate in creating and modifying various types of documents and content may be integrated with multimodal communication systems providing different kinds of communication and collaboration capabilities. Such integrated systems are sometimes referred to as Unified Communication and Collaboration (UC&C) systems.

While UC&C systems provide for increased flexibility in communications, they also present a number of implementation challenges. For instance, a UC&C system typically utilizes multiple interconnected networks to route various communications. Since different networks may be managed by different entities, challenges thus arise in managing communications quality for communications that are routed among independently managed networks. Further, UC&C is typically implemented via software that can be loaded on mobile devices, e.g., tablets, smartphones, laptops, and so forth. Thus, techniques for managing UC&C communication traffic typically have to be fluid and dynamic to accommodate changing connection scenarios.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for subscription for communication attributes are described. According to various embodiments, communication attributes include various descriptive information and state information for entities and data flows across a communication system. According to various embodiments, entities involved in a communication system can subscribe to receive various communication attributes including extended attributes not explicitly identified as being available from a particular entity. According to one or more embodiments, various actions can be performed based on communication attributes, such as to optimize communication performance across a communication system.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 depicts an environment in an example implementation that is operable to employ techniques discussed herein.

FIG. 2 depicts an example implementation scenario for subscribing to receive communication attributes in accordance with one or more embodiments.

FIG. 3 depicts an example implementation scenario for subscribing to receive communication attributes in accordance with one or more embodiments.

FIG. 4 depicts an example attribute catalog in accordance with one or more embodiments.

FIG. 5 is a flow diagram that describes steps in a method for subscribing to network attributes in accordance with one or more embodiments.

FIG. 6 is a flow diagram that describes steps in a method for communicating information further to a subscription for communication attributes in accordance with one or more embodiments.

FIG. 7 is a flow diagram that describes steps in a method for responding to a subscribe request in accordance with one or more embodiments.

FIG. 8 is a flow diagram that describes steps in a method for responding to a subscription request in accordance with one or more embodiments.

FIG. 9 is a flow diagram that describes steps in a method for returning a communication attribute based on a condition in accordance with one or more embodiments.

FIG. 10 is a flow diagram that describes steps in a method for subscribing to receive a communication attribute in accordance with one or more embodiments.

FIG. 11 illustrates an example system and computing device as described with reference to FIG. 1, which are configured to implement embodiments of techniques described herein.

### DETAILED DESCRIPTION

Overview

Techniques for subscription for communication attributes are described. According to various implementations, communication attributes represent attributes of entities involved in different interconnected communication networks, such as communication networks involved in routing communication sessions between different endpoints. Generally, a communication session refers to an exchange of communication media between different communication endpoints, such as in real-time. Examples of a communication session include a Voice over Internet Protocol (VoIP) call, a video call, text messaging, a file transfer, content sharing, and/or combinations thereof. In at least some embodiments, a communication session represents a Unified Communication and Collaboration (UC&C) session.

According to various implementations, communication attributes represent various descriptive information and state information for entities and data flows across a communication system. Examples of different communication attributes are described below.

According to various implementations, entities involved in a communication system can subscribe to receive various communication attributes. For instance, a particular entity exposes an attribute catalog that identifies different sets and instances of communication attributes that the particular entity is capable of providing. Thus, another entity may select a set of communication attributes from the catalog, and may subscribe to receive the set of communication attributes from the particular entity.

Further to techniques discussed herein, a subscribing entity may also subscribe to a communication attribute not explicitly identified as being available from a particular entity, referred to herein as an “extended attribute.” According to various implementations, a subscribing entity can provide guidance information for retrieving an extended attribute, such as location information describing a location from which the extended attribute can be retrieved. Thus, a particular entity receiving a request to subscribe to an extended attribute can leverage the guidance information to retrieve and return the extended attribute.

According to one or more implementations, conditions can be specified for the return of a communication attribute. For instance, a subscribing entity can specify a precondition for the return of a communication attribute, and/or processing to be performed on a communication attribute.

According to one or more implementations, various actions can be performed based on communication attributes. For instance, a network controller for a communication network can change a network configuration setting and/or a communication routing path to optimize network performance and/or communication session performance. As another example, a client device can adjust its own settings based on a communication attribute to optimize its performance, such as part of a communication session. As yet another example, a communication service can propagate a communication attribute among different networks and devices served by the communication service, such as to enable optimization of the different networks and devices. Thus, techniques described herein provide extensible ways of enlightening network entities with communication attributes for performance optimization and error mitigation across a communication system.

In the following discussion, an example environment is first described that is operable to employ techniques described herein. Next, a section entitled “Propagating Communication Attributes” discusses some example ways for propagating communication attributes in accordance with one or more embodiments. Following this, a section entitled “Example Implementation Scenarios” describes some example implementation scenarios in accordance with one or more embodiments. Next, a section entitled “Example Procedures” describes some example procedures in accordance with one or more embodiments. Finally, a section entitled “Example System and Device” describes an example system and device that are operable to employ techniques discussed herein in accordance with one or more embodiments.

Having presented an overview of example implementations in accordance with one or more embodiments, consider now an example environment in which example implementations may by employed.

Example Environment

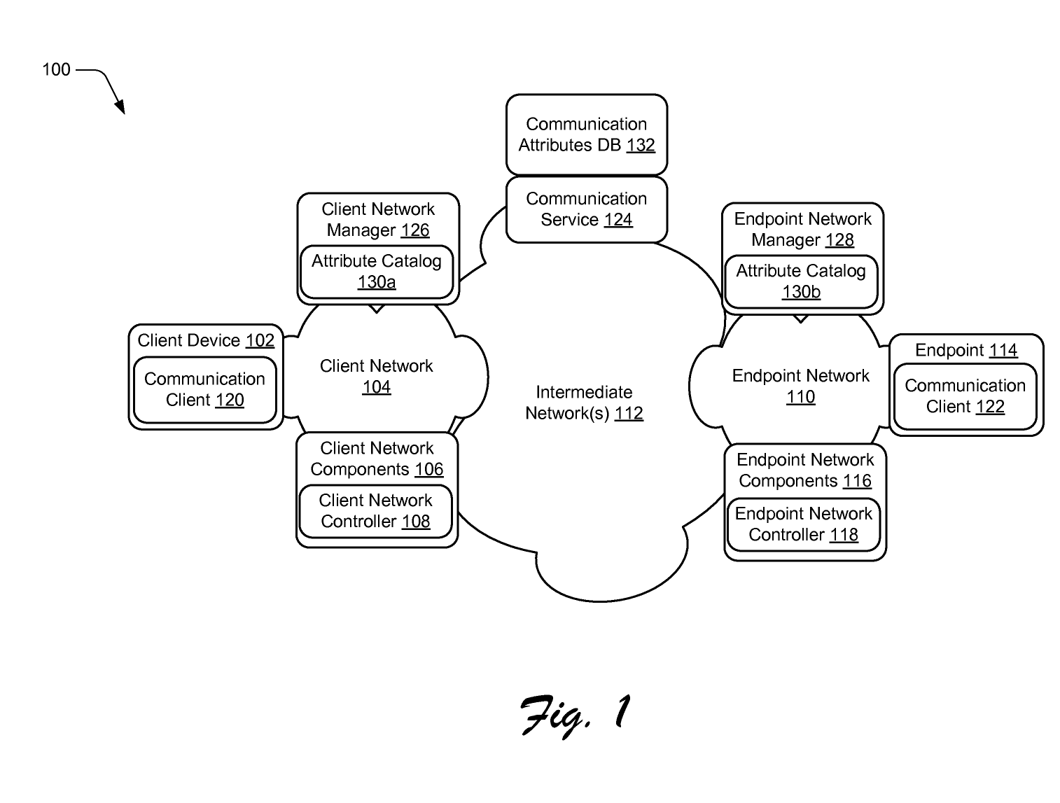

FIG. 1 is an illustration of an environment 100 in an example implementation that is operable to employ techniques for subscription for communication attributes described herein. Generally, the environment 100 represents a communication system that includes various devices, services, and networks that enable communication via a variety of different modalities. For instance, the environment 100 includes a client device 102 connected to a client network 104. The client device 102 may be configured in a variety of ways, such as a traditional computer (e.g., a desktop personal computer, laptop computer, and so on), a mobile station, a cellular phone, an entertainment appliance, a smartphone, a wearable device, a netbook, a game console, a handheld device (e.g., a tablet), a smart appliance (e.g., an Internet of Things (“IoT”) device, and so forth.

The client network 104 is representative of a network that provides the client device 102 with connectivity to various networks and/or services, such as the Internet. The client network 104 may be provided and/or managed by a particular enterprise entity, such as a service provider. The client network 104 may provide the client device 102 with connectivity via a variety of different connectivity technologies, such as broadband cable, digital subscriber line (DSL), wireless cellular, wireless data connectivity (e.g., WiFi™), T-carrier (e.g., T1), Ethernet, and so forth.

The client network 104 includes client network components 106, which are representative of different infrastructure components of the client network 104, such as hardware and logic for implementing and maintaining the client network 104. Examples of the client network components 106 include network switches, routers, gateways, base stations (e.g., cellular base stations), and so forth. The client network components 106, for instance, include a client network controller 108. The client network controller 108 is representative of functionality to manage various aspects of the client network 104, such as connectivity and routing of the client network components 106.

According to various implementations, the client network controller 108 maintains state awareness of the various client network components 106. For example, the client network controller 108 maintains a mapping of the client network components 106 (e.g., in terms of location) and performance attributes of the client network components 106, such as signal quality for the different client network components 106, quality of service (QoS) attributes of the client network components 106, and so forth.

The client network controller 108, for instance, includes connectivity and logic that accesses routing information for the client network components 106. For example, the client network controller 108 can access an Interior Gateway Protocol (IGP) and/or spanning tree switching topology for the client network components 106. This enables the client network controller 108 to identify different data routing paths within the client network 104, and to map and remap the different routing paths.

The client network 104 is connected to an endpoint network 110 via one or more intermediate networks 112. The endpoint network 110 is representative of different types and instances of wired and wireless networks that may be implemented and managed by different respective entities and according to a variety of different networking technologies, such as such as broadband cable, digital subscriber line (DSL), wireless cellular, wireless data connectivity (e.g., WiFi™), T-carrier (e.g., T1), Ethernet, and so forth.

According to various implementations, connectivity between the client network 104 and the endpoint network 110 provides different communication paths between the client device 102 and an endpoint 114. The endpoint 114 is representative of devices and/or functionalities with which the client device 102 may communicate.

The endpoint network 110 includes endpoint network components 116 including an endpoint network controller 118. Generally, the endpoint network controller 118 is representative of functionality to manage various aspects of the endpoint network 110, such as connectivity and routing for the endpoint network components 116. Example attributes and aspects of the endpoint network components 116 are discussed above with reference to the client network components 106.

According to various implementations, communication between the client device 102 and the endpoint 114 is facilitated via a communication client 120 of the client device 102, and a communication client 122 of the endpoint 114. Generally, the communication clients 120, 122 are representative of functionalities to enable different forms of communication via the client device 102 and the endpoint 114. Examples of the communication clients 120, 122 include a voice communication application (e.g., a VoIP client), a video communication application, a messaging application, a content sharing application, a UC&C application, and combinations thereof. The communication clients 120, 122 for instance, enable different communication modalities to be combined to provide diverse communication scenarios.

In at least some implementations, the communication clients 120, 122 represent interfaces to a communication service 124. Generally, the communication service 124 is representative of a service to perform various tasks for management of communication between the client device 102 and the endpoint 114. The communication service 124, for instance, can manage initiation, moderation, and termination of communication sessions between the communication clients 120, 122.

The communication service 124 maintains a presence across many different networks and can be implemented according to a variety of different architectures, such as a cloud-based service, a distributed service, a web-based service, and so forth. Examples of the communication service 124 include a VoIP service, an online conferencing service, a UC&C service, and so forth. In at least some embodiments, the communication service 124 may be implemented as or be connected to a private branch exchange (PBX) in communication with a Public Switched Telephone Network (“PSTN”) to enable voice communication between the client device 102 and other endpoints, such as the endpoint 114.

Further to techniques for subscription for communication attributes discussed herein, various communication attributes may be shared among the various entities of the environment 100. Accordingly, the environment 100 includes a client network manager 126 for the client network 104, and an endpoint network manager 128 for the endpoint network 110. Generally, the client network manager 126 and the endpoint network manager 128 represent functionalities for enabling communication attributes to be propagated to and from their respective networks.

The client network manager 126 includes an attribute catalog 130a, and the endpoint network manager includes an attribute catalog 130b. Generally, the attribute catalogs 130a, 130b represent lists of sets of communication attributes that the client network manager 126 and the endpoint network manager 128 make available to different entities, such as their respective network controllers. According to various implementations, the attribute catalogs 130a, 130b do not store actual values for communication attributes, but list identifiers for types and instances of communication attributes that are available to be retrieved. This is not intended to be limiting, however, and in at least some implementations the attribute catalogs 130a, 130b can include both identifiers and values for communication attributes.

In at least some implementations, the client network 104 and the endpoint network 110 are implemented at least in part as software-defined networks (SDN). Thus, the client network manager 126 and the endpoint network manager 128 may represent SDN managers that receive, process, and/or propagate communication attributes. Portions of the following discussion focus on the client network manager 126 and the client network 104, but it is to be appreciated that similar functionalities and attributes apply to the endpoint network manager 128 and the endpoint network 110.

Generally, communication attributes represent information pertaining to communication across different networks in a communication system, such as information pertaining to routing paths for routing data between the client device 102 and the endpoint 114, attributes of different networks that are independent of a particular communication session, data about specific instances of communication sessions, attributes of networks involved in routing communication sessions, data about users that participate in communication sessions, data about infrastructure components of the different networks, and so forth. Further details concerning communication attributes are described below.

According to various implementations, the client network manager 126 can ascertain communication attributes and can propagate the communication attributes to various entities. For instance, the client network manager 126 can propagate communication attributes to the client network controller 108 to enable the client network controller 108 to maintain state awareness of network attributes and/or attributes of communication sessions. Accordingly, the client network controller 108 can leverage the communication attributes to make intelligent decisions to optimize communication session performance across the client network 104.

According to one or more implementations, the client network manager 126 may be implemented and/or maintained by the communication service 124, such as to propagate communication attributes for communication sessions managed by the communication service 124. Alternatively, the client network manager 126 may be implemented separately and/or independently from the communication service 124. The client network manager 126, for instance, may aggregate and propagate communication attributes for different entities and/or systems involved in communication sessions, such as different communication clients and communication services.

The environment 100 further includes a communication attributes database (DB) 132 that is representative of functionality to track various communication attributes across different networks, such as the client network 104 and the endpoint network 110. For instance, the communication attributes DB 132 may be employed to track state information for various client network components 106, such as performance attributes and statistics for the client network components 106. The client network controller 108, for example, can communicate state information for the client network components 106 to the client network manager 126, which then propagates the state information to the communication attributes DB 132. Further, the client network manager 126 can retrieve communication attributes from the communication attributes DB 132 and propagate the communication attributes to the client network controller 108.

Alternatively or additionally, the client network manager 126 may interact with the communication attributes DB 132 directly, such as to populate communication attributes to and retrieve communication attributes from the communication attributes DB 132. According to various implementations, information from the communication attributes DB 132 can be employed to make various decisions, such as for configuring various settings of the client network components 106 and/or the client device 102 to optimize session performance for communication sessions of the client device 102.

The communication attributes DB 132 may also track communication attributes for various current and historical communication sessions, such as identifiers for individual communication sessions, endpoints involved in individual communication sessions, networks through which individual communication sessions are routed, performance attributes of the communication sessions, and so forth. In at least some implementations, communication attributes pertaining to a communication session can be propagated in a separate data stream from data of the communication session itself Thus, decisions concerning handling and routing of communication session data may be made without processing and/or handling the actual communication session data.

Various entities discussed herein may be referred to in both plural and singular implementations. When an entity is discussed in both plural and singular implementations, a reference to a singular implementation refers to an instance of the plural implementation.

Having described an example environment in which the techniques described herein may operate, consider now a discussion of example ways of propagating routing awareness in accordance with one or more embodiments.

Propagating Communication Attributes

According to various embodiments, techniques can be employed to dynamically enlighten various entities with communication attributes, such as information about network conditions, information about communication sessions, and so forth. For instance, notification events can be generated that include various attributes of networks and communication sessions. The notification events can be propagated to different entities further to techniques for subscription for communication attributes discussed herein.

In at least some embodiments, notification events can be configured using a communication application programming interface (API) that can be leveraged to configure and communicate communication attributes to various entities involved in communication sessions. For example, the communication API can identify dialogue events and session events for which attributes of networks and/or communication sessions can be identified. Consider, for instance, the following events and communication attributes that may be conveyed via a notification event generated using the communication API. In at least some implementations, the communication attributes listed below represent example communication attributes included in the attribute catalogs 130a, 130b.

Dialogue Events—These events apply to various portions of a communication session, such as the start, update, and end of a communication session. A dialogue event can include one or more of the following example communication attributes.

(1) Network Identifier: This attribute can be leveraged to identify a network, such as a network from which a dialogue event is received. In at least some implementations, the network identifier may include an autonomous system (AS) number that identifies a particular network. With reference to the environment 100, for instance, the network identifier may identify the client network 104, an intermediate network 112, and/or the endpoint network 110.

(2) Timestamp: This attribute can be leveraged to specify timestamps for a start of a communication session, updates that occur during a communication session, and an end (e.g., termination) of a communication session.

(3) Source IP Address: This attribute can be leveraged to specify an IP address for a device that is a source of media during a communication session, e.g., a device that initiates a communication session. With reference to the environment 100, for instance, the source IP address may be for the client device 102 or the endpoint 114.

(4) Destination IP Address: This attribute can be leveraged to specify an IP address for a device that is to receive media as part of a communication session. With reference to the environment 100, for instance, the destination IP address may be for the client device 102 or the endpoint 114.

(5) Transport Type: This attribute can be leveraged to specify a transport type or combination of transport types for a communication session. Examples of transport types include Transmission Control Protocol (TCP), User Datagram Protocol (UDP), and so forth.

(6) Source Port: this attribute can be leveraged to specify an identifier for a port at a source device, e.g., a source device identified by the Source IP Address referenced above.

(7) Destination Port: This attribute can be leveraged to specify an identifier for a port at a destination device, e.g., a destination device identified by the Destination IP Address referenced above.

(8) Media Type: This attribute can be leveraged to specify a media type and/or types that are to be transmitted and/or are being transmitted as part of a communication session. A communication session can involve multiple different types of media, such as audio, video, images, and combinations thereof. Thus, the Media Type attribute can be employed to identify media types in a communication session.

(9) Bandwidth Estimation: This attribute can be leveraged to specify an estimated bandwidth that is to be allocated for a communication session. The estimated bandwidth, for instance, can be based on various factors, such as a privilege level associated with a user, type and/or types of media included in a communication session, and so forth.

(10) To: This attribute can be leveraged to identify a user to which media in a communication session is to be transmitted.

(11) From: This attribute can be leveraged to identify a user from which media in a communication session is transmitted.

(12) Codec: This attribute can be leveraged to specify a codec or codecs utilized as part of a communication session.

(13) Error Code: This attribute can be leveraged to specify various error codes for errors that may occur as part of a communication session. For example, errors can include errors that occur during initiation the communication session, errors that occurred during a communication session, errors that occur when a communication session is terminated, and so forth.

Session Problem Events—These events can be generated and applied when a communication session experiences errors, performance degradation, and so forth. A session problem event may include one or more of the attributes discussed above with reference to Dialogue Events, and may also include one or more of the following communication attributes.

(1) Mean Opinion Score (MOS) Degradation: This attribute can be leveraged to specify a MOS for a communication session. The attribute, for instance, can be used to indicate that an overall quality of a communication session has decreased.

(2) Jitter Inter-Arrival Time: This attribute can be leveraged to specify jitter values for a communication session. The attribute, for instance, can be used to indicate that a jitter value or values have increased, e.g., have exceeded a specified jitter value threshold.

(3) Packet Loss Rate: This attribute can be leveraged to specify a packet loss rate for a communication session. The attribute, for instance, can be used to indicate that a packet loss rate has increased, e.g., has exceeded a specified packet loss rate value threshold.

(4) Round Trip Delay (RTD): This attribute can be leveraged to specify RTD values for packets in communication sessions. The attribute, for instance, can be used to indicate that RTD values for packets have increased, e.g., have exceeded a specified RTD value threshold.

(5) Concealment Ratio: This attribute can be leveraged to specify a cumulative ratio of concealment time over speech time observed after starting a communication session. The attribute, for instance, can be used to specify that a concealment ratio has increased, e.g., has exceeded a specified concealment ratio value threshold.

Network Performance Events—These events can be generated and applied to specify various network attributes, as well as behaviors and performance parameters that are observed for a particular network. For instance, a network performance event may be communicated to a particular entity (e.g., a network controller) to provide the entity with routing awareness. A network performance event may include one or more of the attributes discussed above with reference to Dialogue Events, and may also include one or more of the following communication attributes.

(1) Mean Opinion Score (MOS) levels: This attribute can be leveraged to indicate a MOS observed for communication sessions that traverse a particular network. The MOS for a network, for instance, can be determined by averaging MOS over multiple different communication sessions.

(2) Jitter Inter-Arrival Time: This attribute can be leveraged to specify jitter values observed for communication session data in a particular network.

(3) Packet Loss Rate: This attribute can be leveraged to specify packet loss rate observed for communication session data in a particular network.

(4) Round Trip Delay (RTD): This attribute can be leveraged to specify RTD values observed for communication session data in a particular network.

(5) Concealment Ratio: This attribute can be leveraged to indicate an observed cumulative ratio of concealment time over speech time observed for communication session data in a particular network.

(6) Routing Policy: This attribute can be leveraged to specify different routing policies, such as security policies, service level policies, quality of service (QoS) policies, and so forth. A routing policy, for instance, may be specific to particular networks, to individual communication sessions, and so forth.

Thus, various notifications discussed herein can include one or more of the communication attributes discussed above and can be used to propagate communication attributes to various entities. In at least some implementations, attributes can be linked to particular networks and/or network components to characterize performance attributes of the networks and/or network components.

Having described an example ways of propagating communication attributes, consider now some example implementation scenarios for propagating communication attributes in accordance with one or more embodiments.

Example Implementation Scenarios

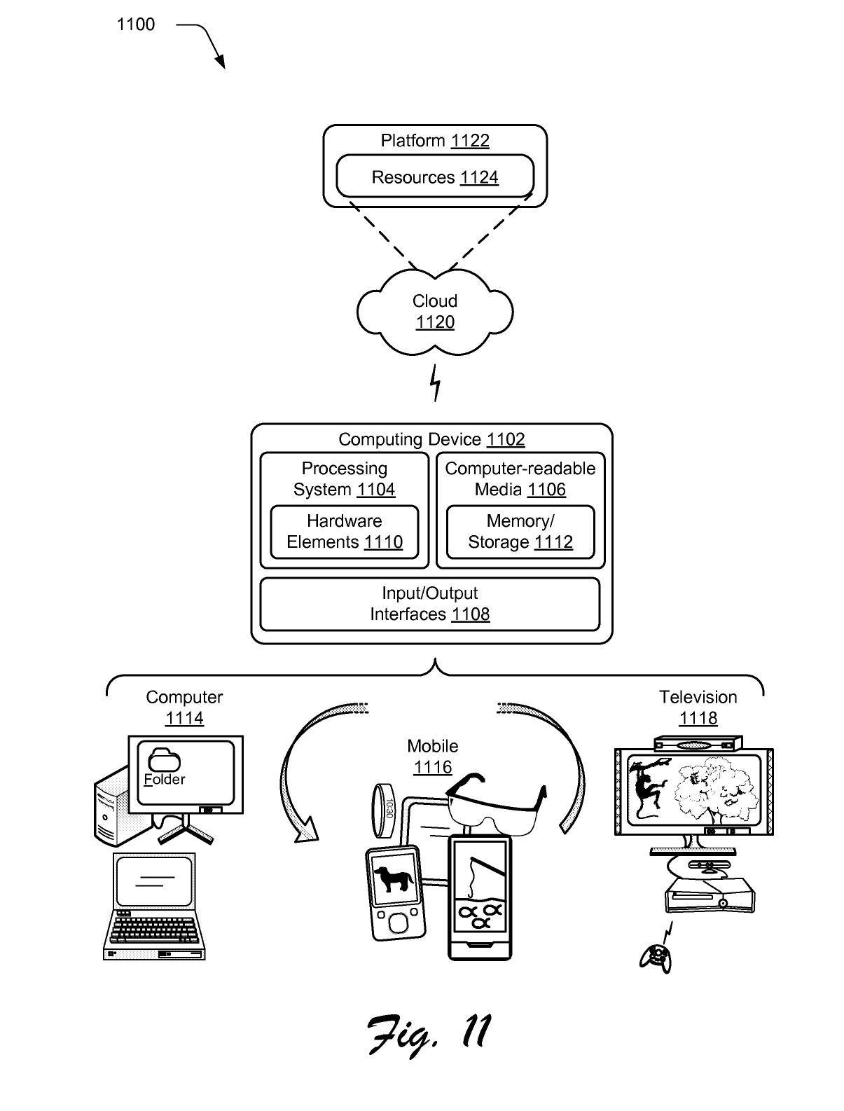

The following section describes example implementation scenarios for subscription for communication attributes in accordance with one or more implementations. The implementation scenarios may be implemented in the environment 100 discussed above, the system 1100 described with reference to FIG. 11, and/or any other suitable environment.

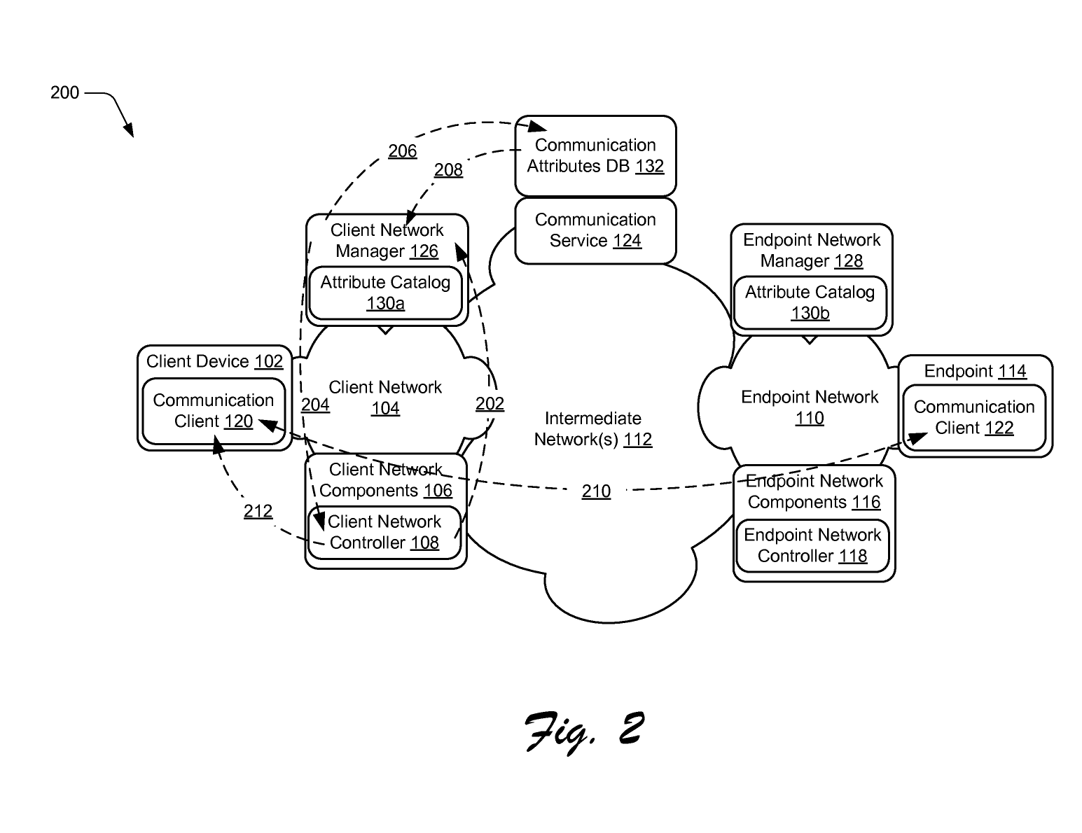

FIG. 2 illustrates an example implementation scenario 200 for subscribing to receive communication attributes in accordance with one or more implementations. The scenario 200 includes various entities and components introduced above with reference to the environment 100.

In the scenario 200, the client network controller 108 communicates a subscription event 202 to the client network manager 126 requesting a set of communication attributes. In at least some implementations, the set of communication attributes are selected from the attribute catalog 130a. For instance, the client network manager 126 communicates the attribute catalog 130a to the client network controller 108. The client network controller 108 then selects one or more communication attributes from the attribute catalog 130a, and populates identifiers for the selected communication attributes to the subscription event 202.

As further detailed below, the subscription event 202 may include communication attributes not explicitly identified in the attribute catalog 130a, referred to herein as an “extended attribute.” In such a scenario, the subscription event 202 may include guidance information (e.g., instructions) to assist the client network manager 126 in locating and/or obtaining the extended attribute. Further details concerning identifying and locating extended attributes are provided below.

In at least some implementations, the subscription event 202 may further identify a set of communication attributes that the client network controller 108 is capable of providing, such as to the client network manager 126 and/or other entity. For instance, the client network manager 126 can provide various attributes of the client network components 106 to other entities. Thus, the subscription event 202 may identify a requested set of communication attributes to be provided to the client network controller 108, and may also identify a different available set of communication attributes that the client network controller 108 is capable of providing.

Continuing with the scenario 200, the client network manager 126 retrieves a set of requested communication attributes and communicates a subscription response 204 to the client network controller 108. The subscription response 204, for instance, includes values for communication attributes requested in the subscription event 202. Further, the subscription response includes one or more values for an extended attribute requested in the subscription event 202. For instance, utilizing guidance information from the subscription event 202 that describes the extended attribute, the client network manager 126 retrieves the extended attribute and populates the extended attribute to the subscription response 204.

The subscription response 204 may further identify a set of communication attributes requested by the client network manager 126. For instance, the client network manager 126 requests a set of communication attributes that are available to the client network controller 108. Further, the requested communication attributes may include communication attributes known to the client network controller 108 and an extended attribute not explicitly known by the client network controller to be available. Thus, techniques for subscription for communication attributes discussed herein can be employed to request extended communication attributes from a variety of different entities involved in communication systems.

In at least some implementations, the client network manager 126 obtains at least some of the communication attributes included in the subscription response 204 from the communication attributes DB 132. For instance, the client network manager 126 communicates a DB query 206 to the communication attributes DB 132 requesting at least some of the communication attributes requested in the subscription event 202. The communication attributes DB 132 returns a DB response 208 to the client network manager 126 including the requested communication attributes. The client network manager 126 populates the communication attributes from the DB response 208 to the subscription response 204, and communicates the subscription response 204 to the client network controller 108.

According to various implementations, the client network controller 108 can make various decisions and perform various actions based on communication attributes included in the subscription response 204. For instance, the client network controller 108 can cause various actions to be performed to optimize performance of a communication session 210 between the client device 102 and the endpoint 114. Examples of such actions include changing a setting of a client network component 106, rerouting the communication session 210 through different client network components 106, rerouting the communication session 210 to a different intermediate network 112, and so forth.

The communication session 210 generally represents an exchange of communication data between the client device 102 and the endpoint 114. Examples of the communication session 210 include a voice call (e.g., a VoIP call), a video call, an online meeting, a UC session, combinations thereof, and so forth.

As another example, the client network controller 108 communicates a notification event 212 to the client device 102 to enable performance of the client device 102 and/or the communication session 210 to be optimized. For example, the notification event 212 includes one or more of the communication attributes from the subscription response 204. Alternatively or additionally, the notification event 212 includes setting changes and/or optimization instructions generated by the client network controller 108 based on processing of the communication attributes. Thus, one or more settings of the client device 102 can be changed to optimize performance of the client device 102 and/or the communication session 210.

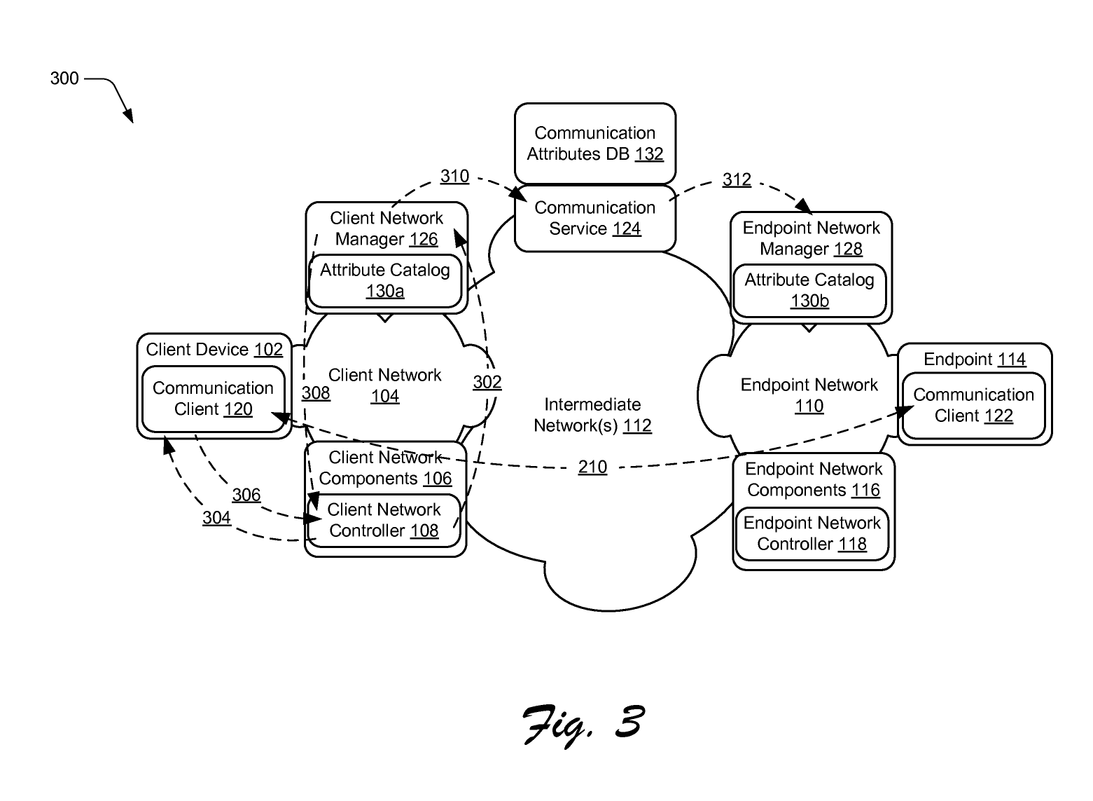

FIG. 3 illustrates an example implementation scenario 300 for subscribing to receive communication attributes in accordance with one or more implementations. The scenario 300, for instance, represents an extension the scenario 200 discussed above. The scenario 300 includes various entities and components introduced above with reference to the environment 100.

In the scenario 300, the client network controller 108 communicates a subscription response 302 to the client network manager 126 that includes various communication attributes requested by the client network manager 126. The communication attributes, for instance, were requested by the client network manager 126 as part of the subscription response 204 described above.

In at least some implementations, the communication attributes included in the subscription response 302 are determined by the client network controller 108 by observing various settings and/or behaviors of the client network components 106. As another example, the client network controller 108 communicates a status query 304 to the client device 102 for local information that resides on the client device 102. Examples of such local information include settings of the client device 102, performance attributes and/or statistics of the client device 102 (e.g., for the communication session 210), user and/or device identification information, and so forth. The client device 102 then communicates a query response 306 to the client network controller 108 that includes the requested local communication attributes. The client network controller 108 populates the communication attributes from the query response 306 to the subscription response 302.

According to various implementations, the subscription response 302 includes one or more extended attributes requested by the client network manager 126 in the subscription response 204. The extended attributes, for instance, represent communication attributes not specifically known to the client network controller. However, in requesting the extended attributes, the client network manager 126 includes guidance information for assisting the client network controller 108 in retrieving the extended attributes. Examples of such information are provided below.

In at least some implementations, the client network manager 126 can make various decisions and perform various actions based on the communication attributes from the subscription response 302. For instance, the client network manager 126 can process the communication attributes to determine an action that can be taken to optimize performance of the client network components 106 and/or the communication session 210. The client network manager 126 then communicates an instruction event 308 to the client network controller 108 to perform the action, such as to change a setting of a client network component 118, to reroute the communication session 210, and so forth.

As another example, the client network manager 126 communicates a notification event 310 to the communication service 124 that includes communication attributes from the subscription response 302. The client network manager 126, for instance, represents an agent of the communication service 124 that can propagate various information to the communication service 124.

The communication service 124 may then perform various actions based on the communication attributes in the notification event 310. For instance, the communication service 124 populates the communication attributes to the communication attributes DB 132 such that the communication attributes can be accessed by other entities by querying the communication attributes DB 132. As another example, the communication service 124 communicates a notification event 312 to the endpoint network manager 128 that includes at least some of the communication attributes from the notification event 310. The endpoint network manager 128 may then utilize the communication attributes to perform various actions, such to optimize performance of the endpoint network 110 and/or the endpoint 114 (e.g., for the communication session 210), communicating the communication attributes to the endpoint network controller 118, and so forth.

Thus, the scenarios 200, 300 illustrate that subscription to communication attributes is multi-directional such that an entity may both subscribe to receive communication attributes from a different entity, and may provide the different entity with other communication attributes.

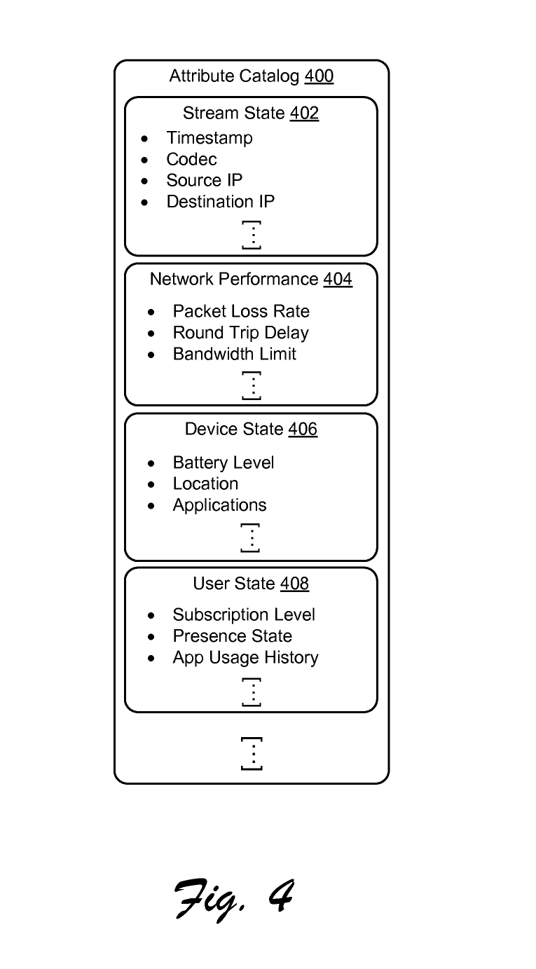

FIG. 4 depicts an example attribute catalog 400 in accordance with one or more implementations. The attribute catalog 400, for instance, represents an implementation of one or more of the attribute catalogs 130a, 130b. Alternatively or additionally, the attribute catalog 400 represents a catalog of communication attributes maintained by a different entity, such as the client network controller 108, the communication attributes DB 132, and so forth.

According to various implementations, the attribute catalog 400 includes different sets of communication attributes that can be retrieved and propagated to various entities as described elsewhere herein. For instance, the attribute catalog includes stream state attributes 402, network performance attributes 404, device state attributes 406, and user state attributes 408. These particular sets of communication attributes are presented for purpose of example only, and it is to be appreciated that a wide variety of other types and instances of communication attributes may be maintained in accordance with techniques for subscription for communication attributes described herein.

The stream state attributes 402 represent communication attributes that describe various attributes of a data stream for a communication session. Examples of the stream state attributes 402 are depicted in FIG. 4 and described above with reference to the communication API.

The network performance attributes 404 represent communication attributes that describe various attributes of a network, such as current and historical performance attributes. With reference to the scenarios described above, for example, the network performance attributes 404 include performance attributes for the client network components 106 of the client network 104. Examples of the network performance attributes 404 are depicted in FIG. 4 and described above with reference to network performance events of the communication API.

The device state attributes 406 represent communication attributes that describe various attributes of a device, such as the client device 102. Examples of the device state attributes 406 are depicted in FIG. 4, but may include various other device state attributes.

The user state attributes 408 represent communication attributes that describe various attributes of a user, such as a user of the client device 102. Examples of the user state attributes 408 are depicted in FIG. 4, but may include various other user state attributes.

Thus, as depicted in the attribute catalog 400, various communication attributes may be tracked such that the communication attributes can be propagated to various entities involved in communication systems. Further, the communication attributes may be categorized into sets that can be utilized to reference and locate individual communication attributes. As referenced above, techniques discussed herein enable extended attributes to be requested that are not specifically listed in the attribute catalog 400. In such a scenario, a requesting entity may reference a set of communication attributes within which the extended attribute may be found.

For instance, with reference to the stream state attributes 402, a requesting entity may request user identification information (e.g., a user name) for a user involved in a communication session even though the user identification information is not expressly listed in the stream state attributes 402. To do so, the requesting entity provides an extended attribute request that references the “stream state” set and specifies a location (e.g., address) within a communication stream at which the user identification information may be found. Accordingly, another entity that receives the extended attribute request utilizes information within the request to retrieve the user identification information, such as by inspecting the communication stream and/or by querying a different entity with the request. Thus, techniques for subscription for communication attributes described herein provide ways of generating a request for an extended attribute that includes instructions and/or assistance in locating and retrieving the extended attribute.

Accordingly, these example scenarios describe that techniques for subscription for communication attributes discussed herein may be employed to subscribe to and propagate communication attributes among various entities involved in a communication system, and that the existing sets of communication attributes are extendable to include extended attributes not specifically known to an entity from which the extended attributes are requested. The communication attributes can be leveraged in various ways, such as for optimizing network performance and performance of communication sessions, mitigating errors that occur and/or may occur in the communication sessions, and so forth.

Having discussed some example implementation scenarios, consider now a discussion of some example procedures in accordance with one or more embodiments.

Example Procedures

The following discussion describes some example procedures for subscription for communication attributes in accordance with one or more embodiments. The example procedures may be employed in the environment 100 of FIG. 1, the system 1100 of FIG. 11, and/or any other suitable environment. The procedures, for instance, represent example procedures for implementing the implementation scenarios described above. In at least some embodiments, the steps described for the various procedures can be implemented automatically and independent of user interaction. While various aspects of the procedures are discussed with reference to the client network controller 108 and the client network manager 126, it is to be appreciated that the same aspects apply to the endpoint network controller 118 and the endpoint network manager 128.

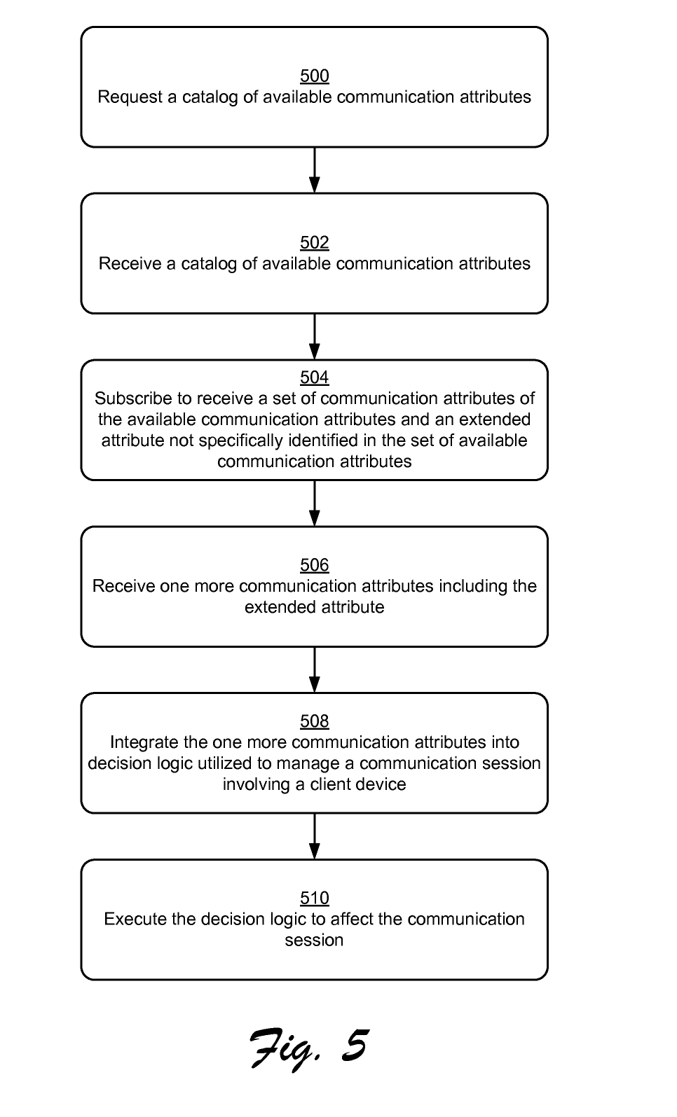

FIG. 5 is a flow diagram that describes steps in a method in accordance with one or more implementations. The method describes an example procedure for subscribing to network attributes in accordance with one or more implementations.

Step 500 requests a catalog of available communication attributes. The client network controller 108, for example, communicates a request to the client network manager 126 for identifiers for communication attributes that are available from the client network manager 126.

Step 502 receives a catalog of available communication attributes. The client network controller 108, for example, receives the attribute catalog 130a from client network manager 126. As described above, the attribute catalog 130a identifies various communication attributes that are available from the client network manager 126.

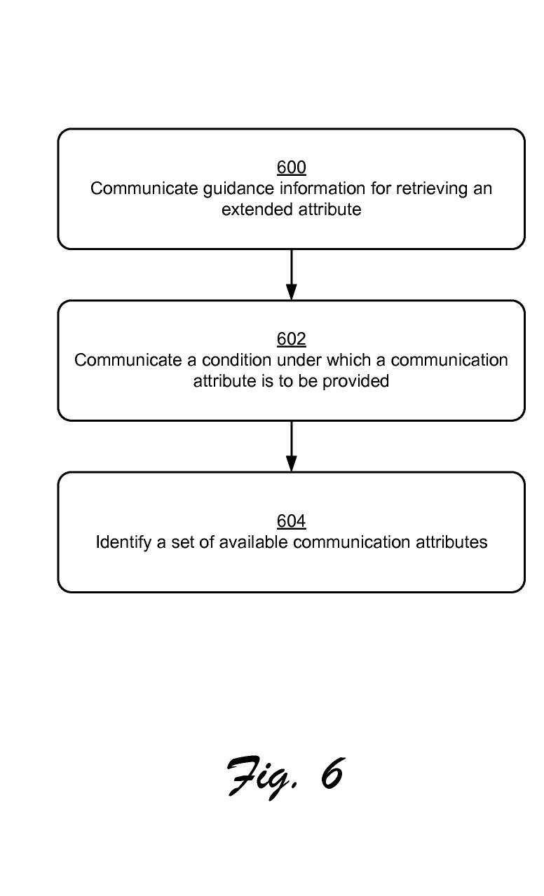

Step 504 subscribes to receive a set of communication attributes of the available communication attributes and an extended attribute not specifically identified in the set of available communication attributes. The client network controller 108, for example, communicates a subscription request to the client network manager 126 requesting to receive values for communication attributes that are identified in the available communication attributes, as well as values for at least one extended attribute not specifically identified in the available communication attributes. According to various implementations, other information is provided along with the subscription request, such as described below with reference to FIG. 6.

Step 506 receives one more communication attributes including the extended attribute. The client network controller 108, for example, receives one or more of the subscribed available communication attributes along with the extended attribute.

Step 508 integrates the one more communication attributes into decision logic utilized to manage a communication session involving a client device. The client network controller 108, for example, utilizes the one or more communication attributes as one or more values for internal logic of the client network controller 108. Generally, the decision logic represents machine-executable instructions that are executable by the client network controller 108.

Step 510 executes the decision logic to affect the communication session. The client network controller 108, for example, executes the decision logic to optimize performance of a device (e.g., the client device 102 and/or a client network component 106) and/or a communication session. Alternatively or additionally, executing the decision logic mitigates and/or prevents an error condition. For instance, executing the decision logic can cause an action to be performed, such as changing a setting of a client network component 106, changing a setting of the client device 102 and/or the communication client 120, rerouting a communication session within the client network 104 and/or other network, and so forth.

FIG. 6 is a flow diagram that describes steps in a method in accordance with one or more implementations. The method describes an example procedure for communicating information further to a subscription for communication attributes in accordance with one or more implementations. The method, for instance, describes an example extension of step 504 of the procedure described above.

Step 600 communicates guidance information for retrieving an extended attribute. Generally, the guidance information represents information to assist in retrieving the extended attribute and is included along with a subscription request. The guidance information may take various forms. For instance, the guidance information can identify a set of communication attributes in which the extended attribute is located. Examples of sets of communication attributes are described above with reference to FIG. 4.

As another example, the guidance information specifies an address at which the extended attribute is located. The address, for instance, is a uniform resource locator (URL) for the extended attribute and/or for a location at which the extended attribute is located.

As yet another example, the guidance information includes a set of one or more query terms that can be used to query a database of communication attributes for the extended attribute. The client network manager 126, for example, queries the communication attributes DB 132 with the set of query terms, and the communication attributes DB 132 returns the extended attribute in response to the query.

These examples of guidance information are provided for purpose of example only, and it is to be appreciated that guidance information may take a variety of different forms not explicitly described herein.

Step 602 communicates a condition under which a communication attribute is to be provided. The condition, for instance, represents a precondition to communicating a communication attribute, such as an extended attribute. For example, the condition specifies a condition that is to be true or a condition that is to be false before the communication attribute is communicated. As an example, the condition may specify that the communication attribute is not to include personally identifiable information (PII), that the communication attribute be within a certain timestamp range, and so forth.

As another example, the condition may specify an operation that is to be performed on the communication attribute. Examples of such an operation include encryption, decryption, ordering, filtering, and so forth.

Step 604 identifies a set of available communication attributes. The client network controller 108, for instance, communicates a set of different communication attributes that the client network controller 108 is capable of providing to the client network manager 126 and/or other entity.

While this procedure is described as a series of steps, it is to be appreciated that the steps may be performed individually and separately from one another.

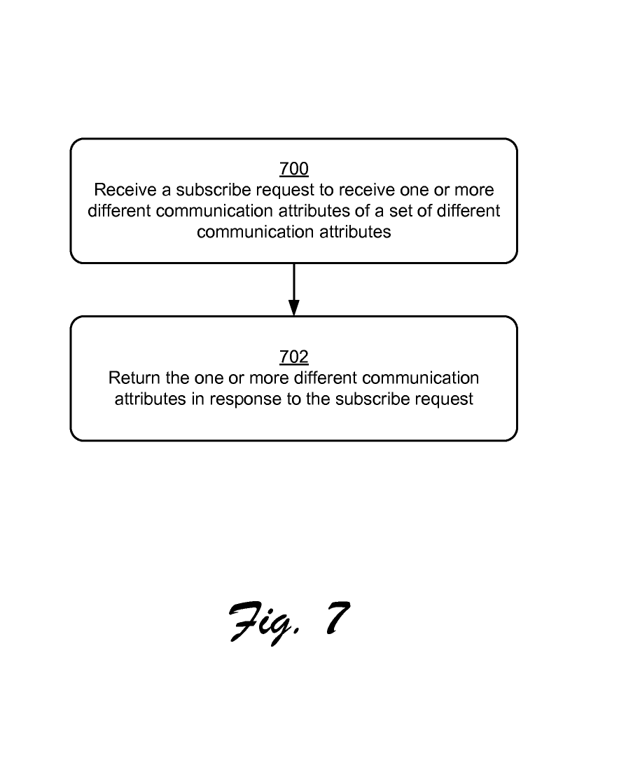

FIG. 7 is a flow diagram that describes steps in a method in accordance with one or more implementations. The method describes an example procedure for responding to a subscribe request in accordance with one or more implementations. The method, for instance, describes an example extension of the method described above with reference to FIG. 5.

Step 700 receives a subscribe request to receive one or more different communication attributes of a set of different communication attributes. The client network controller 108, for instance, receives the subscribe request from the client network manager 126.

Step 702 returns the one or more different communication attributes in response to the subscribe request. The client network controller 108, for instance, returns the one or more different communication attributes to the client network manager 126.

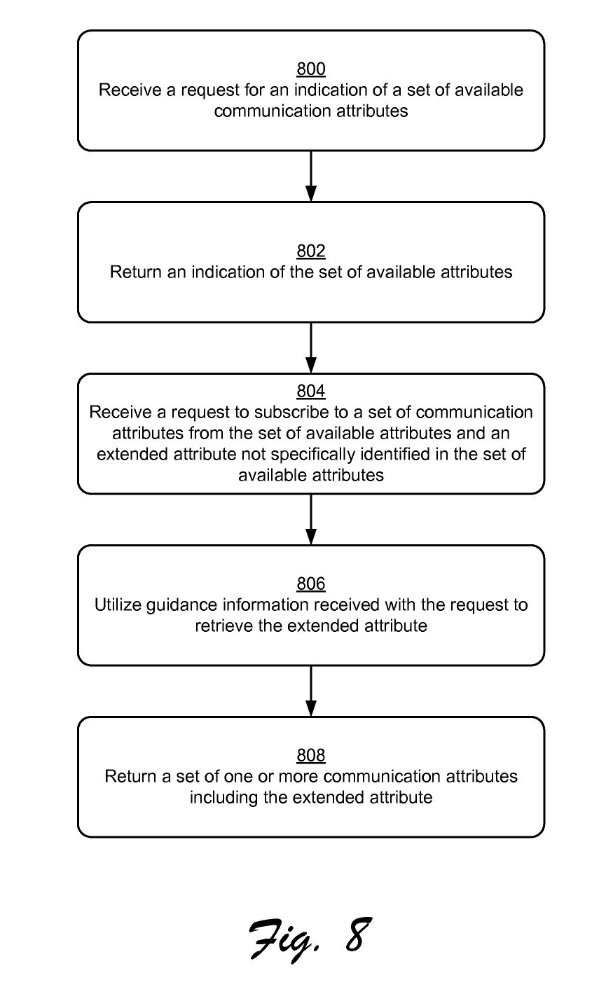

FIG. 8 is a flow diagram that describes steps in a method in accordance with one or more implementations. The method describes an example procedure for responding to a subscription request in accordance with one or more implementations.

Step 800 receives a request for an indication of a set of available communication attributes. The client network manager 126, for example, receives a request from the client network controller 108 for the attribute catalog 130a.

Step 802 returns an indication of the set of available attributes. The client network manager 126, for example, returns the attribute catalog 130a to the client network controller 108. As described above in the discussion of the environment 100, providing the attribute catalog 130a generally provides identifiers for available communication attributes but does not provide actual values for the available communication attributes.

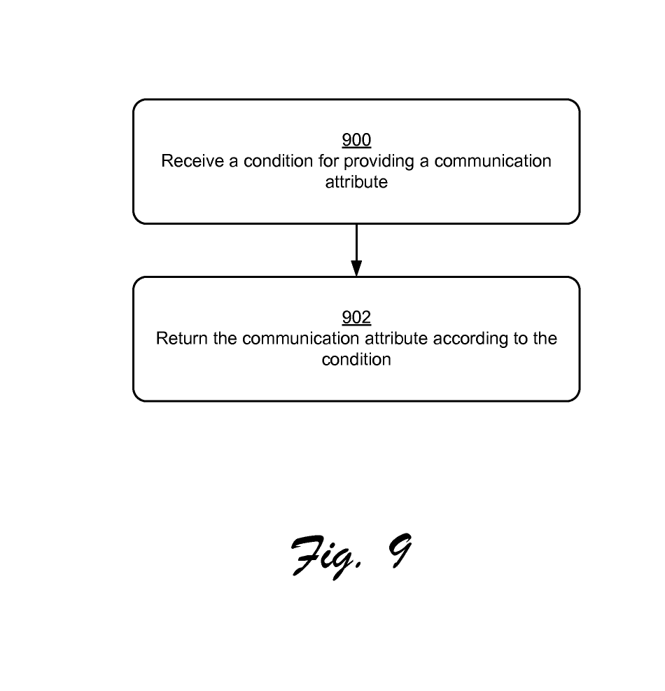

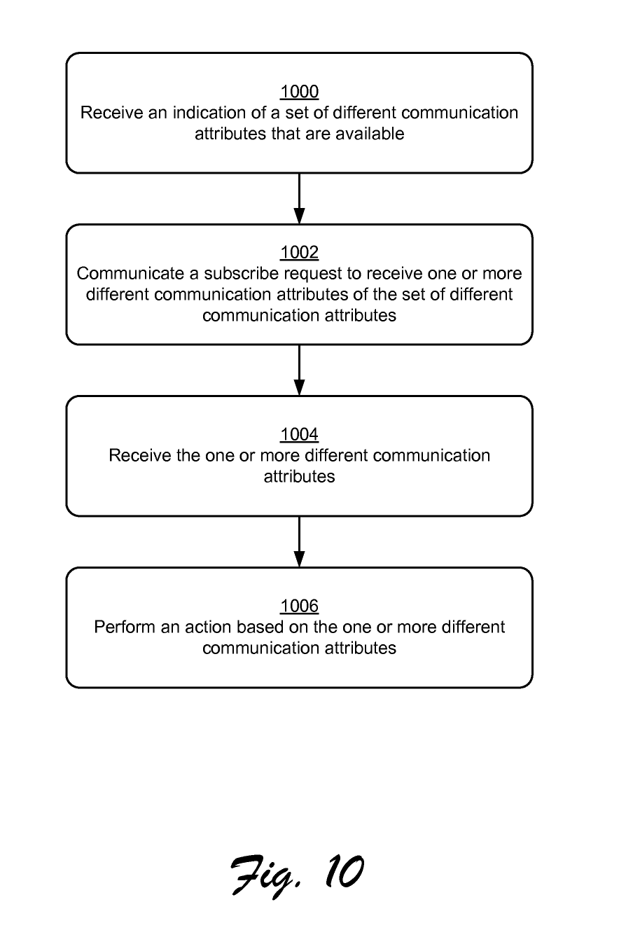

Step 804 receives a request to subscribe to a set of communication attributes from the set of available attributes and an extended attribute not specifically identified in the set of available attributes. The request, for instance, includes identifiers for a set of available communication attributes and an identifier for an extended attribute. Further, the request includes various other information, such as guidance information for retrieving the extended attribute. Examples of other information received with the request are discussed above as well as below with reference to FIGS. 9 and 10.

Step 806 utilizes guidance information received with the request to retrieve the extended attribute. The client network manager 126, for example, utilizes the guidance information to locate and retrieve the extended attribute. The guidance information may take various forms, examples of which are discussed above. For instance, the guidance information may identify a set of communication attributes in which the extended attribute is located. Thus, utilizing the guidance information may include retrieving the extended attribute from the identified set of communication attributes.

As another example, the guidance information specifies an address (e.g., URL) at which the extended attribute is located. Thus, utilizing the guidance information may include retrieving the extended attribute from a location identified by the address.

As yet another example, the guidance information includes a set of one or more query terms that can be used to query a database of communication attributes for the extended attribute. The client network manager 126, for example, queries the communication attributes DB 132 with the set of query terms, and the communication attributes DB 132 returns the extended attribute in response to the query.

Step 808 returns a set of one or more communication attributes including the extended attribute. The client network manager 126, for example, returns the set of one or more communication attributes including the extended attribute to the client network controller 108 to cause the client network controller 108 to perform an action to affect a communication session across the client network 104. Various actions that can be taken to affect a communication session are described above.

FIG. 9 is a flow diagram that describes steps in a method in accordance with one or more implementations. The method describes an example procedure for returning a communication attribute based on a condition in accordance with one or more implementations.

Step 900 receives a condition for providing a communication attribute. The client network manager 126, for example, receives the condition as part of a subscription request from the client network controller 108 for a set of communication attributes. In at least some implementations, the condition pertains to an extended attribute.

Step 902 returns the communication attribute according to the condition. The condition, for instance, may specify a precondition for the communication attribute to be returned and/or processing to be applied to the communication attribute before it is returned.

In a scenario where the condition specifies a precondition, the condition may specify a condition that is to be true or a condition that is to be false before the communication attribute is communicated. If the precondition is not satisfied, the communication attribute may be processed to satisfy the precondition. In at least some implementations, if the precondition is not capable of being satisfied, the communication attribute is not returned.

In a scenario where the condition specifies processing to be applied, the processing is applied to the communication attribute before returning the communication attribute. Examples of such an operation include encryption, decryption, ordering, filtering, and so forth.

FIG. 10 is a flow diagram that describes steps in a method in accordance with one or more implementations. The method describes an example procedure for subscribing to receive a communication attribute in accordance with one or more implementations. The method, for example, represents an extension of the method described above with reference to FIG. 8.

Step 1000 receives an indication of a set of different communication attributes that are available. The client network manager 126, for instance, receives the indication from the client network controller 108. In at least some implementations, the indication is received along with a subscription request from the client network controller 108.

Step 1002 communicates a subscribe request to receive one or more different communication attributes of the set of different communication attributes. The client network manager 126, for instance, communicates the subscribe request to the client network controller 108. In at least some implementations, the subscribe request identifies an extended attribute that is not specifically identified by the client network controller 108 as being available. In such a scenario, the subscribe request may include guidance information for retrieving the extended attribute and/or a condition under which the extended attribute is to be provided.

Step 1004 receives the one or more different communication attributes. The client network manager 126, for instance, receives the one or more different communication attributes including an extended attribute from the client network controller 108.

Step 1006 performs an action based on the one or more different communication attributes. The client network manager 126, for example, performs an action based on the one or more different communication attributes. For instance, the client network manager 126 performs a network configuration event to reconfigure one or more operational parameters of the client network 104, such as to optimize network performance. As another example, the client network manager 126 communicates the one or more different communication attributes to a different entity, such as the communication service 124, the communication attributes DB 132, and so forth. For example, the communication service 124 may utilize the one or more different communication attributes to optimize performance of a communication session.

According to various implementations, the procedures described above are performed dynamically and in response to various events. For instance, when an entity ascertains that a communication attribute can be leveraged to perform an action to optimize network and/or communication session performance, the entity can submit a subscription request for the communication attribute according to techniques discussed herein. Thus, the scenarios and procedures described above may be periodically and/or continually performed, such as to maintain current state information across a communication system, to adapt to changing conditions in a communication system, to respond to a decrease in communication quality in a communication system, to mitigate errors in communication data, and so forth.

Accordingly, techniques discussed herein provide a wide variety of scenarios and implementations for subscribing to and propagating communication attributes among different entities involved in a communication system. Generally, communication attributes enable such entities to make informed decisions regarding processing, routing, and handling of communication data.

Having discussed some example procedures, consider now a discussion of an example system and device in accordance with one or more embodiments.

Example System and Device

FIG. 11 illustrates an example system generally at 1100 that includes an example computing device 1102 that is representative of one or more computing systems and/or devices that may implement various techniques described herein. For example, the client device 102, the endpoint 114, the client network controllers 108, 118, and/or the client network managers 126, 128 discussed above with reference to FIG. 1 can be embodied as the computing device 1102. The computing device 1102 may be, for example, a server of a service provider, a device associated with the client (e.g., a client device), an on-chip system, and/or any other suitable computing device or computing system.

The example computing device 1102 as illustrated includes a processing system 1104, one or more computer-readable media 1106, and one or more Input/Output (I/O) Interfaces 1108 that are communicatively coupled, one to another. Although not shown, the computing device 1102 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1104 is representative of functionality to perform one or more operations using hardware. Accordingly, the processing system 1104 is illustrated as including hardware element 1110 that may be configured as processors, functional blocks, and so forth. This may include implementation in hardware as an application specific integrated circuit or other logic device formed using one or more semiconductors. The hardware elements 1110 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1106 is illustrated as including memory/storage 1112. The memory/storage 1112 represents memory/storage capacity associated with one or more computer-readable media. The memory/storage 1112 may include volatile media (such as random access memory (RAM)) and/or nonvolatile media (such as read only memory (ROM), Flash memory, optical disks, magnetic disks, and so forth). The memory/storage 1112 may include fixed media (e.g., RAM, ROM, a fixed hard drive, and so on) as well as removable media (e.g., Flash memory, a removable hard drive, an optical disc, and so forth). The computer-readable media 1106 may be configured in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone (e.g., for voice recognition and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 1102 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “entity,” “manager,” “controller,” “service,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1102. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1102, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 1110 and computer-readable media 1106 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 1110. The computing device 1102 may be configured to implement particular instructions and/or functions corresponding to the software and/or hardware modules. Accordingly, implementation of modules that are executable by the computing device 1102 as software may be achieved at least partially in hardware, e.g., through use of computer-readable storage media and/or hardware elements 1110 of the processing system. The instructions and/or functions may be executable/operable by one or more articles of manufacture (for example, one or more computing devices 1102 and/or processing systems 1104) to implement techniques, modules, and examples described herein.

As further illustrated in FIG. 11, the example system 1100 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1100, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 1102 may assume a variety of different configurations, such as for computer 1114, mobile 1116, and television 1118 uses. Each of these configurations includes devices that may have generally different constructs and capabilities, and thus the computing device 1102 may be configured according to one or more of the different device classes. For instance, the computing device 1102 may be implemented as the computer 1114 class of a device that includes a personal computer, desktop computer, a multi-screen computer, laptop computer, netbook, and so on.

The computing device 1102 may also be implemented as the mobile 1116 class of device that includes mobile devices, such as a mobile phone, portable music player, portable gaming device, a tablet computer, a wearable device, a multi-screen computer, and so on. The computing device 1102 may also be implemented as the television 1118 class of device that includes devices having or connected to generally larger screens in casual viewing environments. These devices include televisions, set-top boxes, gaming consoles, and so on.

The techniques described herein may be supported by these various configurations of the computing device 1102 and are not limited to the specific examples of the techniques described herein. For example, functionalities discussed with reference to the client network managers 126, 128, the client network controllers 108, 118, and/or the communication service 124 may be implemented all or in part through use of a distributed system, such as over a “cloud” 1120 via a platform 1122 as described below.

The cloud 1120 includes and/or is representative of a platform 1122 for resources 1124. The platform 1122 abstracts underlying functionality of hardware (e.g., servers) and software resources of the cloud 1120. The resources 1124 may include applications and/or data that can be utilized while computer processing is executed on servers that are remote from the computing device 1102. Resources 1124 can also include services provided over the Internet and/or through a subscriber network, such as a cellular or Wi-Fi network.

The platform 1122 may abstract resources and functions to connect the computing device 1102 with other computing devices. The platform 1122 may also serve to abstract scaling of resources to provide a corresponding level of scale to encountered demand for the resources 1124 that are implemented via the platform 1122. Accordingly, in an interconnected device embodiment, implementation of functionality described herein may be distributed throughout the system 1100. For example, the functionality may be implemented in part on the computing device 1102 as well as via the platform 1122 that abstracts the functionality of the cloud 1120.

Discussed herein are a number of methods that may be implemented to perform techniques discussed herein. Aspects of the methods may be implemented in hardware, firmware, or software, or a combination thereof. The methods are shown as a set of steps that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

Implementations discussed herein include:

Example 1: A system including: at least one processor; and one or more computer-readable storage media including instructions stored thereon that, responsive to execution by the at least one processor, cause the system perform operations including: subscribing to receive a set of communication attributes identified in a set of available communication attributes and an extended attribute not specifically identified in the set of available communication attributes, the set of available communication attributes and the extended attribute pertaining to a communication system; receiving one more communication attributes including the extended attribute; integrating the one more communication attributes into decision logic utilized to manage a communication session involving a client device of the communication system; and executing the decision logic to affect the communication session.

Example 2: A system as recited in example 1, wherein the operations are performed by a network controller of a communication network that provides network connectivity to the client device.

Example 3: A system as recited in one or more of examples 1 or 2, wherein the operations are performed by a software defined network (SDN) manager that performs SDN management functions for the communication system.

Example 4: A system as recited in one or more of examples 1-3, wherein the operations are performed by a network controller of a communication network that provides network connectivity to the client device, and wherein said subscribing includes communicating a subscription request to a software defined network (SDN) manager that performs SDN management functions for the communication system.

Example 5: A system as recited in one or more of examples 1-4, wherein said subscribing includes communicating a subscription request to a software defined network (SDN) manager that performs SDN management functions for the communication system, and wherein the set of available communication attributes includes an attribute catalog for the SDN manager.

Example 6: A system as recited in one or more of examples 1-5, wherein said subscribing includes providing guidance information for retrieving the extended attribute.

Example 7: A system as recited in one or more of examples 1-6, wherein said subscribing includes providing guidance information for retrieving the extended attribute, the guidance information including one or more of an identifier for an attribute set in which the extended attribute is located, or an address at which the extended attribute is located.

Example 8: A system as recited in one or more of examples 1-7, wherein said subscribing includes specifying an operation to be performed on the extended attribute before it is communicated in response to said subscribing.

Example 9: A system as recited in one or more of examples 1-8, wherein said subscribing includes specifying a condition under which the extended attribute is to be communicated in response to said subscribing.

Example 10: A system as recited in one or more of examples 1-9, wherein said subscribing includes identifying a set of different communication attributes that are available, and wherein the operations further include: receiving a subscribe request to receive one or more different communication attributes of the set of different communication attributes; and returning the one or more different communication attributes in response to the subscribe request.

Example 11: A computer-implemented method, including: receiving a request from a network entity of a communication network to subscribe to a set of communication attributes identified in a set of available communication attributes and an extended attribute not specifically identified in the set of available communication attributes, the set of available communication attributes and the extended attribute pertaining to a communication system and the request including guidance information for retrieving the extended attribute; utilizing the guidance information to retrieve the extended attribute; and returning a set of one or more communication attributes including the extended attribute to the network entity to cause the network entity to perform an action to affect a communication session across the communication network.

Example 12: A method as described in example 11, wherein the network entity includes a network controller for the communication network.

Example 13: A method as described in one or more of examples 11 or 12, wherein the guidance information includes one or more of instructions for locating the extended attribute, an identifier for a set of communication attributes in which the extended attribute is located, or an address for the extended attribute.

Example 14: A method as described in one or more of examples 11-13, wherein said utilizing includes querying a communication attribute database with the guidance information to retrieve the extended attribute from the communication attribute database.

Example 15: A method as described in one or more of examples 11-14, wherein the request from the network entity specifies a condition under which the extended attribute is to be provided, and wherein said returning includes returning the extended attribute to the network entity according to the specified condition.

Example 16: A method as described in one or more of examples 11-15, wherein the request from the network entity specifies an operation to be performed on the extended attribute, and wherein the method further includes performing the operation on the extended attribute before returning the extended attribute to the network entity.

Example 17: A method as described in one or more of examples 11-16, further including: receiving an indication of a set of different communication attributes available from the network entity; communicating a subscription request to the network entity to receive one or more different communication attributes of the set of communication attributes; and receiving the one or more different communication attributes.

Example 18: A computer-implemented method, including: subscribing by a network controller of a communication network to receive a set of communication attributes identified in a set of available communication attributes and an extended attribute not specifically identified in the set of available communication attributes, the set of available communication attributes and the extended attribute pertaining to a communication system to which the communication network is connected; receiving at the network controller one more communication attributes including the extended attribute; integrating the one more communication attributes into decision logic utilized by the network controller to manage a communication session involving a client device of the communication network; and executing the decision logic to affect the communication session.

Example 19: A method as described in example 18, wherein said subscribing includes providing guidance information for retrieving the extended attribute, and wherein the guidance information includes one or more of instructions for locating the extended attribute, an identifier for a set of communication attributes in which the extended attribute is located, or an address for the extended attribute.

Example 20: A method as described in one or more of examples 18 or 19, wherein said subscribing includes one or more of specifying an operation to be performed on the extended attribute before it is communicated in response to said subscribing, or specifying a condition under which the extended attribute is to be communicated in response to said subscribing.

### CONCLUSION

Techniques for subscription for communication attributes are described. Although embodiments are described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A system comprising:
at least one processor; and
one or more computer-readable storage media including instructions stored thereon that, responsive to execution by the at least one processor, cause the system perform operations including:
subscribing to receive a set of communication attributes identified in a set of available communication attributes and an extended attribute not specifically identified in the set of available communication attributes, the set of available communication attributes and the extended attribute pertaining to a communication system;
receiving one more communication attributes including the extended attribute;
integrating the one more communication attributes into decision logic utilized to manage a communication session involving a client device of the communication system; and
executing the decision logic to affect the communication session.

2. A system as recited in claim 1, wherein the operations are performed by a network controller of a communication network that provides network connectivity to the client device.

3. A system as recited in claim 1, wherein the operations are performed by a software defined network (SDN) manager that performs SDN management functions for the communication system.

4. A system as recited in claim 1, wherein the operations are performed by a network controller of a communication network that provides network connectivity to the client device, and wherein said subscribing comprises communicating a subscription request to a software defined network (SDN) manager that performs SDN management functions for the communication system.

5. A system as recited in claim 1, wherein said subscribing comprises communicating a subscription request to a software defined network (SDN) manager that performs SDN management functions for the communication system, and wherein the set of available communication attributes comprises an attribute catalog for the SDN manager.

6. A system as recited in claim 1, wherein said subscribing includes providing guidance information for retrieving the extended attribute.

7. A system as recited in claim 1, wherein said subscribing includes providing guidance information for retrieving the extended attribute, the guidance information including one or more of an identifier for an attribute set in which the extended attribute is located, or an address at which the extended attribute is located.

8. A system as recited in claim 1, wherein said subscribing includes specifying an operation to be performed on the extended attribute before it is communicated in response to said subscribing.

9. A system as recited in claim 1, wherein said subscribing includes specifying a condition under which the extended attribute is to be communicated in response to said subscribing.

10. A system as recited in claim 1, wherein said subscribing includes identifying a set of different communication attributes that are available, and wherein the operations further include:
receiving a subscribe request to receive one or more different communication attributes of the set of different communication attributes; and
returning the one or more different communication attributes in response to the subscribe request.

11. A computer-implemented method, comprising:
receiving a request from a network entity of a communication network to subscribe to a set of communication attributes identified in a set of available communication attributes and an extended attribute not specifically identified in the set of available communication attributes, the set of available communication attributes and the extended attribute pertaining to a communication system and the request including guidance information for retrieving the extended attribute;
utilizing the guidance information to retrieve the extended attribute; and
returning a set of one or more communication attributes including the extended attribute to the network entity to cause the network entity to perform an action to affect a communication session across the communication network.

12. A method as described in claim 11, wherein the network entity comprises a network controller for the communication network.

13. A method as described in claim 11, wherein the guidance information includes one or more of instructions for locating the extended attribute, an identifier for a set of communication attributes in which the extended attribute is located, or an address for the extended attribute.

14. A method as described in claim 11, wherein said utilizing comprises querying a communication attribute database with the guidance information to retrieve the extended attribute from the communication attribute database.

15. A method as described in claim 11, wherein the request from the network entity specifies a condition under which the extended attribute is to be provided, and wherein said returning comprises returning the extended attribute to the network entity according to the specified condition.

16. A method as described in claim 11, wherein the request from the network entity specifies an operation to be performed on the extended attribute, and wherein the method further comprises performing the operation on the extended attribute before returning the extended attribute to the network entity.

17. A method as described in claim 11, further comprising:
receiving an indication of a set of different communication attributes available from the network entity;
communicating a subscription request to the network entity to receive one or more different communication attributes of the set of communication attributes; and
receiving the one or more different communication attributes.

18. A computer-implemented method, comprising:
subscribing by a network controller of a communication network to receive a set of communication attributes identified in a set of available communication attributes and an extended attribute not specifically identified in the set of available communication attributes, the set of available communication attributes and the extended attribute pertaining to a communication system to which the communication network is connected;
receiving at the network controller one more communication attributes including the extended attribute;
integrating the one more communication attributes into decision logic utilized by the network controller to manage a communication session involving a client device of the communication network; and
executing the decision logic to affect the communication session.

19. A method as described in claim 18, wherein said subscribing includes providing guidance information for retrieving the extended attribute, and wherein the guidance information includes one or more of instructions for locating the extended attribute, an identifier for a set of communication attributes in which the extended attribute is located, or an address for the extended attribute.

20. A method as described in claim 18, wherein said subscribing includes one or more of specifying an operation to be performed on the extended attribute before it is communicated in response to said subscribing, or specifying a condition under which the extended attribute is to be communicated in response to said subscribing.
